(19) United States
(12) Patent Application Publication
(10) Pub. No.: US 2018/0230278 A1
(43) Pub. Date: Aug. 16, 2018

(54) POLYIMIDE-BASED FILM, COMPOSITION FOR PREPARING POLYIMIDE-BASED FILM, DISPLAY DEVICE INCLUDING POLYIMIDE-BASED FILM, AND INDENTATION HARDNESS ESTIMATING METHOD THEREOF

(71) Applicants: SAMSUNG ELECTRONICS CO., LTD., Suwon-si (KR); Samsung SDI Co., Ltd., Yongin-si (KR)

(72) Inventors: Sunghyun HAN, Pohang-si (KR); Chanjae AHN, Suwon-si (KR); Won Suk CHANG, Hwaseong-si (KR); A Ra JO, Euiwang-si (KR); Sungwon CHOI, Hwaseong-si (KR)

(21) Appl. No.: 15/656,376

(22) Filed: Jul. 21, 2017

(30) Foreign Application Priority Data
Feb. 14, 2017 (KR) 10-2017-0020053

(51) Int. Cl. C08J 5/18; C08G 73/14; C08G 73/10; G01N 3/42; G01N 3/44

(52) U.S. Cl. CPC C08J 5/18; C08G 73/14; C08G 73/1039; C08J 2379/08; C08G 73/1078; G01N 3/42; G01N 3/44; C08G 73/1042

(57) ABSTRACT

A polyimide film, which is a reaction product of a diamine including an amide structural unit in an amount of greater than about 0 mol % and less than or equal to about 80 mol % and an aromatic dianhydride, wherein the polyimide film has a Martens hardness of about 14 N/mm² to about 120 N/mm² at a thickness of about 30 μm to about 100 μm.

### CROSS-REFERENCE TO RELATED APPLICATION

This application claims priority to Korean Patent Application No. 10-2017-0020053 filed in the Korean Intellectual Property Office on Feb. 14, 2017, and all the benefits accruing therefrom under 35 U.S.C. § 119, the content of which is incorporated herein in its entirety by reference.

### BACKGROUND

### 1. Field

A polyimide film, a composition for preparing the polyimide film, a display device including the same, and an indentation hardness-estimating method of the polyimide film are disclosed.

### 2. Description of the Related Art

As availability of information has grown, there has been an increasing demand for display devices that consume a small amount of power, that are light and flexible as paper, and that can be used anywhere and at any time as a display for visualizing information and delivering it to users. However, the flexible display device is complex, and requires a flexible substrate, organic and inorganic materials for a low temperature process, flexible electronics, and sealing and packing technology.

A transparent plastic film used in a flexible display device, that has replaced a conventional window cover glass, requires high hardness.

The transparent plastic film needs to satisfy an important hardness parameter such as surface hardness and indentation hardness in order to be actually applied to the flexible display device. The surface hardness may be used to evaluate scratch resistance and other parameters of the flexible display device, and the indentation hardness may be used to evaluate whether or not the transparent plastic film protects an internal element and a module in substantially the same manner as the conventional window cover glass.

Specifically, the surface hardness of the transparent plastic film may be directly measured using a pencil hardness method and the like. However, the indentation hardness of the transparent plastic film is difficult to directly measure due to its low thickness of less than or equal to tens of millimeters or several to hundreds of micrometers.

### SUMMARY

An embodiment of the present disclosure provides a polyimide film having improved hardness, which can be applied to a window film for a display device, and particularly, to a flexible display device and the like, and a hardness-estimating method of directly measuring indentation hardness of the polyimide film.

According to an embodiment, a polyimide film is a reaction product of a diamine including an amide structural unit in an amount of greater than about 0 mole percent and less than or equal to about 80 mole percent with an aromatic dianhydride, wherein the polyimide film has a Martens hardness of about 14 Newtons per square millimeter to about 120 Newtons per square millimeter at a thickness of about 30 micrometers to about 100 micrometers.

The diamine may be a reaction product of an aromatic diamine represented by Chemical Formula 1 and an aromatic dicarbonyl compound represented by Chemical Formula 2:

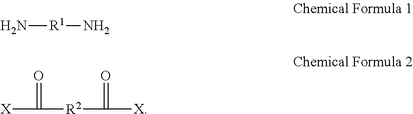

In Chemical Formula 1, R¹ includes a substituted or unsubstituted C6 to C30 aromatic organic group, wherein the aromatic organic group is present as a single ring; as a condensed ring system including two or more fused rings; or as a ring system including two or more aromatic rings linked together by a single bond or a functional group selected from a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

In Chemical Formula 2, R² is a substituted or unsubstituted phenylene group or biphenylene group, and X is a halogen atom.

R¹ of Chemical Formula 1 may be substituted or unsubstituted two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof, wherein a substituent of the substituted ring system is selected from —OH, —CF₃, —CCl₃, —CBr₃, —Cl₃, —NO₂, —CN, —COCH₃, and —CO₂C₂H₅.

R¹ of Chemical Formula 1 may be two or more phenylene groups linked together by a single bond and independently substituted with a substituent selected from —CF₃, —CCl₃, —CBr₃, —Cl₃, —NO₂, —CN, —COCH₃, and —CO₂C₂H₅.

R² of Chemical Formula 2 may be an unsubstituted phenylene group, and X may be Cl.

The aromatic dianhydride may be represented by Chemical Formula 3:

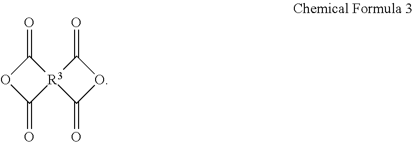

In Chemical Formula 3, R³ includes a substituted or unsubstituted C6 to C30 aromatic organic group, wherein the aromatic organic group is present as a single ring; as a condensed ring system including two or more fused rings; or as a ring system including two or more aromatic rings linked together by a single bond or a functional group selected from a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

R³ of Chemical Formula 3 may be substituted or unsubstituted two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

Chemical Formula 3 may be represented by Chemical Formula 4:

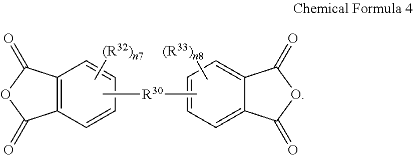

In Chemical Formula 4,

R³⁰ is a single bond, —O—, —S—, —C(═O)—, —CH(OH)—, —C(═O)NH—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein 1≤n≤10, 1≤p≤10, and 1≤q≤10) group,

R³² and R³³ are independently a halogen, a hydroxy group, a substituted or unsubstituted C1 to C10 aliphatic organic group, a substituted or unsubstituted C6 to C20 aromatic organic group, a —OR³⁰¹ group (wherein, R³⁰¹ is a C1 to C10 aliphatic organic group), or a —SiR³¹⁰R³¹¹R³¹² group (wherein R³¹⁰, R³¹¹, and R³¹² are independently hydrogen or a C1 to C10 aliphatic organic group), and

n7 and n8 are independently one of integers of 0 to 3.

The aromatic dianhydride represented by Chemical Formula 4 may be a combination of a compound, wherein R³⁰ is a single bond and n7 and n8 are each 0 and a compound, wherein R³⁰ is —C(CₙF₂ₙ₊₁)₂— (wherein, 1≤n≤10) and n7 and n8 are each 0.

The polyimide film may be a reaction product including about 40 mole percent to about 80 mole percent of the aromatic dicarbonyl compound represented by Chemical Formula 2, based on a total amount of the dianhydride and the aromatic dicarbonyl compound.

The aromatic dianhydride represented by Chemical Formula 4 may include about 10 mole percent to about 30 mole percent of 6FDA, based on a total amount of the dianhydride and the aromatic dicarbonyl compound.

According to another embodiment, a composition for preparing a polyimide film includes amide structural unit-containing diamine represented by Chemical Formula 5 and dianhydride represented by Chemical Formula 4:

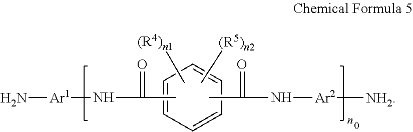

In Chemical Formula 5,

R⁴ and R⁵ are independently a halogen, a hydroxy group, a substituted or unsubstituted C1 to C10 alkyl group, or a substituted or unsubstituted C1 to C10 alkoxy group,

n0 is an integer of 1 or more,

n1 and n2 are independently an integer ranging from 0 to 4, provided that n1+n2 is an integer of 0 to 4, and

Ar¹ and Ar² are independently represented by Chemical Formula 6:

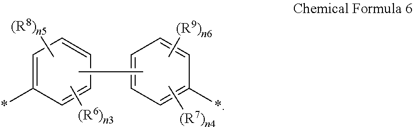

In Chemical Formula 6,

R⁶ and R⁷ are independently an electron-withdrawing group selected from —CF₃, —CCl₃, —CBr₃, —Cl₃, —NO₂, —CN, —COCH₃, and —CO₂C₂H₅,

R⁸ and R⁹ are the same or different and are independently a halogen, a hydroxy group, an alkoxy group (—OR³⁰⁴, wherein R³⁰⁴ is a C1 to C10 aliphatic organic group), a silyl group (—SiR³⁰⁵R³⁰⁶R³⁰⁷, wherein R³⁹⁶, R³⁹⁶, and R³⁰⁷ are the same or different and are independently hydrogen, a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4:

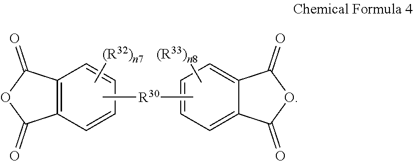

In Chemical Formula 4,

R³⁰ is a single bond, —O—, —S—, —C(═O)—, —CH(OH)—, —C(═O)NH—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein 1 ≤n≤10, and 1≤q≤10) group,

R³² and R³³ are independently a halogen, a hydroxy group, a substituted or unsubstituted C1 to C10 aliphatic organic group, a substituted or unsubstituted C6 to C20 aromatic organic group, a —OR³⁰¹ group (wherein, R³⁰¹ is a C1 to C10 aliphatic organic group), or a —SiR³¹⁰R³¹¹R³¹² group (wherein R³¹⁰, R³¹¹, and R³¹² are independently hydrogen or a C1 to C10 aliphatic organic group), and

n7 and n8 are independently one of integers of 0 to 3.

The composition for preparing a polyimide film may further include an aromatic diamine represented by Chemical Formula 7.

Chemical Formula 7

H₂N—Ar³—NH₂

In Chemical Formula 7, Ar³ is represented by Chemical Formula 6:

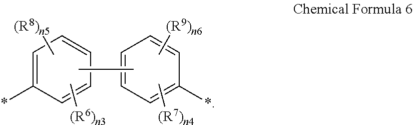

In Chemical Formula 6,

R⁶ and R⁷ are independently an electron withdrawing group selected from —CF₃, —CCl₃, —CBr₃, —Cl₃, —NO₂, —CN, —COCH₃, and —CO₂C₂H₅,

R⁸ and R⁹ are the same or different and are independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷ wherein R²⁰⁵, R²⁰⁶, and R²⁰⁷ are the same or different and are independently hydrogen, a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4.

In Chemical Formula 5, the amide structural unit denoted by n0 may be included in an amount of about 40 mole percent to about 80 mole percent, based on a total sum of a mole number of the amide structural unit and a mole number of the aromatic dianhydride represented by Chemical Formula 4.

The aromatic dianhydride represented by Chemical Formula 4 may include about 10 mole percent to about 30 mole percent of 6FDA, based on a total sum of a mole number of the amide structural unit denoted by n0 and a mole number of the aromatic dianhydride in the diamine represented by Chemical Formula 5.

According to another embodiment, a display device includes the polyimide film.

According to another embodiment, an indentation hardness estimating method of a polyimide film, that is a method for measuring an indentation hardness of the polyimide film, includes:

preparing a laminate including a substrate, an adhesion layer disposed on the substrate, and the polyimide film disposed on the adhesion layer,

measuring a force applied to the laminate and an indentation depth of the laminate while indenting the laminate using an indenter, and

estimating an indentation hardness of the polyimide film using the measured force applied to the laminate and the indentation depth of the laminate.

The indentation depth of the laminate may be less than or equal to a sum of a thickness of the polyimide film and a thickness of the adhesion layer.

The method may include increasing the force applied to the polyimide film so that indentation depth of the laminate may be greater than or equal to a thickness of the polyimide film.

Accordingly, a polyimide film having improved hardness, and thus, applicable to a window film for a flexible display device and the like and a display device including the same, may be provided.

In addition, a novel indentation hardness measuring method of directly measuring indentation hardness of the polyimide film having various thicknesses may be provided.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic view showing a laminate including a polyimide-based film according to an embodiment,

FIGS. 2 and 3 are schematic views showing the laminate of the FIG. 1 when indented up to less than or equal to an elastic limit of the polyimide-based film,

FIGS. 4 and 5 are schematic views showing the laminate of FIG. 1 when indented up to greater than an elastic limit of the polyimide-based film, and

FIG. 6 is a graph of force (milliNewtons, mN) versus displacement (micrometers, μm) showing relationship of a force applied to the laminate of FIG. 1 relative to an indentation depth of polyimide-based film (displacement).

### DETAILED DESCRIPTION

Hereinafter, exemplary embodiments will be described in detail so that a person skilled in the art would understand the same. This disclosure may, however, be embodied in many different forms and is not construed as limited to the exemplary embodiments set forth herein. Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of” when preceding a list of elements, modify the entire list of elements and do not modify the individual elements of the list.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

As used herein, when a definition is not otherwise provided, ‘substituted’ refers to replacement of at least one hydrogen of a functional group of a specific Chemical Formula by a substituent selected from a halogen atom (F, Br, Cl, or I), a hydroxy group, a nitro group, a cyano group, an amino group {NH₂, NH(R¹⁰⁰), or N(R¹⁰¹)(R¹⁰²) wherein R¹⁰⁰, R¹⁰¹, and R¹⁰² are the same or different, and are independently a C1 to C10 alkyl group}, an amidino group, a hydrazine group, a hydrazone group, a carboxyl group, an ester group, a ketone group, a substituted or unsubstituted alkyl group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, and a substituted or unsubstituted heterocyclic group or the substituents may be linked with each other to form a ring.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1 to C30 alkyl” refers to a C1 to C30 alkyl group substituted with C6 to C30 aryl group, the total number of carbon atoms in the resulting aryl substituted alkyl group is C7 to C60.

As used herein, when specific definition is not otherwise provided, the term “alkyl group” refers to a C1 to C30 alkyl group, for example, a C1 to C15 alkyl group, the term “cycloalkyl group” refers to a C3 to C30 cycloalkyl group, for example, a C3 to C18 cycloalkyl group, the term “alkoxy group” refers to a C1 to C30 alkoxy group, for example, a C1 to C18 alkoxy group, the term “ester group” refers to a C2 to C30 ester group, for example, a C2 to C18 ester group, the term “aryl group” refers to a C6 to C30 aryl group, for example, a C6 to C18 aryl group, the term “alkenyl group” refers to a C2 to C30 alkenyl group including at least one double bond, for example, a C2 to C18 alkenyl group, the term “alkynyl group” refers to a C2 to C30 alkynyl group including at least one triple bond, for example, a C2 to C18 alkynyl group, the term “alkylene group” refers to a C1 to C30 alkylene group, for example, a C1 to C18 alkylene group, and the term “arylene group” refers to a C6 to C30 arylene group, for example, a C6 to C16 arylene group.

As used herein, when specific definition is not otherwise provided, the term “aliphatic organic group” refers to a substituted or unsubstituted C1 to C30 alkyl group, a substituted or unsubstituted C2 to C30 alkenyl group, a substituted or unsubstituted C2 to C30 alkynyl group, a substituted or unsubstituted C1 to C30 alkylene group, a substituted or unsubstituted C2 to C30 alkenylene group, or a substituted or unsubstituted C2 to C30 alkynylene group, for example, a substituted or unsubstituted C1 to C15 alkyl group, a substituted or unsubstituted C2 to C15 alkenyl group, a substituted or unsubstituted C2 to C15 alkynyl group, a substituted or unsubstituted C1 to C15 alkylene group, a substituted or unsubstituted C2 to C15 alkenylene group, or a substituted or unsubstituted C2 to C15 alkynylene group, the term “alicyclic organic group” refers to a substituted or unsubstituted C3 to C30 cycloalkyl group, a substituted or unsubstituted C3 to C30 cycloalkenyl group, a substituted or unsubstituted C3 to C30 cycloalkynyl group, a substituted or unsubstituted C3 to C30 cycloalkylene group, a substituted or unsubstituted C3 to C30 cycloalkenylene group, or a substituted or unsubstituted C3 to C30 cycloalkynylene group, for example, substituted or unsubstituted C3 to C15 cycloalkyl group, a substituted or unsubstituted C3 to C15 cycloalkenyl group, a substituted or unsubstituted C3 to C15 cycloalkynyl group, a substituted or unsubstituted C3 to C15 cycloalkylene group, a substituted or unsubstituted C3 to C15 cycloalkenylene group, or a substituted or unsubstituted C3 to C15 cycloalkynylene group, the term “aromatic organic group” refers to a single aromatic ring, a condensed ring system including two or more aromatic rings, or a ring system including two or more aromatic rings linked together by a single bond, or a fluorenylene group, a functional group selected from —O—, —S—, C—(═O)—, —CH(OH)—, 13 S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, and —C(═O)NH—, particularly —S(═O)₂—, a C6 to C30 group, for example, a substituted or unsubstituted C6 to C30 aryl group, or a substituted or unsubstituted C6 to C30 arylene group, for example, a substituted or unsubstituted C6 to C16 aryl group, or a C6 to C16 arylene group such as a substituted or unsubstituted phenylene group, the term “hetero cyclic group” refers to a substituted or unsubstituted C2 to C30 cycloalkyl group, a substituted or unsubstituted C2 to C30 cycloalkylene group, a substituted or unsubstituted C2 to C30 cycloalkenyl group, a substituted or unsubstituted C2 to C30 cycloalkenylene group, a substituted or unsubstituted C2 to C30 cycloalkynyl group, a substituted or unsubstituted C2 to C30 cycloalkynylene group, a substituted or unsubstituted C2 to C30 heteroaryl group, or a substituted or unsubstituted C2 to C30 heteroarylene group that include 1 to 3 heteroatoms selected from O, S, N, P, Si, and a combination thereof in a single ring, for example, a substituted or unsubstituted C2 to C15 cycloalkyl group, a substituted or unsubstituted C2 to C15 cycloalkylene group, a substituted or unsubstituted C2 to C15 cycloalkenyl group, a substituted or unsubstituted C2 to C15 cycloalkenylene group, a substituted or unsubstituted C2 to C15 cycloalkynyl group, a substituted or unsubstituted C2 to C15 cycloalkynylene group, a substituted or unsubstituted C2 to C15 heteroaryl group, or a substituted or unsubstituted C2 to C15 heteroarylene group that include 1 to 3 heteroatoms selected from O, S, N, P, Si, and a combination thereof in a single ring.

As used herein, when specific definition is not otherwise provided, the term “combination” refers to mixing or copolymerization.

As used herein, “polyimide-based film” refers to a “poly(amide-imide) copolymer film” as well as a “polyimide film”. In addition, “polyamic acid” is a precursor of “polyimide”, but may have same meaning as polyimide as needed.

As used herein, “*” indicates a linking point with another atom.

Research on making a mobile device such as a smart phone, a tablet PC, or the like light, flexible, and bendable has been conducted, and accordingly, a transparent window film for a display, which is flexible and has high hardness to replace a hard glass on the uppermost of the mobile device, is required.

An important hardness parameter such as surface hardness and indentation hardness may be applied to determine whether or not the transparent window film is actually used for a flexible display. The surface hardness may be used to evaluate scratch resistance and the like of the flexible display, and the indentation hardness may be used to evaluate whether or not the transparent plastic film protects an internal element and a module sufficiently enough to replace a conventional window cover glass.

A polyimide or poly(amide-imide) film has improved mechanical, thermal, and optical characteristics, and thus, is widely used as a substrate for a display device such as an organic light emitting diode (OLED), a liquid crystal display (LCD), and the like. This polyimide or poly(amide-imide) film requires much higher hardness in order to be used as a window film for a flexible display. However, the hardness of the polyimide or poly(amide-imide) film is difficult to improve from several micrometers to hundreds of micrometers thickness up to greater than or equal to a predetermined level.

Accordingly, the inventors of the present application have made an attempt to develop a polyimide-based film having sufficiently high hardness to reliably protect an internal element and a module, particularly when used as a window film, and a composition for the polyimide-based film, and as a result, discovered how to improve Martens hardness of the polyimide-based film up to about 14 Newtons per millimeter (N/mm²) to about 120 N/mm² when measured at a thickness of about 30 micrometers (μm) to about 100 μm by reacting a diamine including an amide structural unit in an amount of greater than about 0 mole percent (mol %) and less than or equal to about 80 mol % with an aromatic dianhydride.

Accordingly, an embodiment provides a polyimide-based film prepared from a reaction product of an amide structural unit-containing diamine including an amide structural unit in an amount of greater than about 0 mol % and less than or equal to about 80 mol % with an aromatic dianhydride, and having a Martens hardness of about 14 N/mm² to about 120 N/mm² at a thickness of about 30 μm to about 100 μm.

The amide structural unit-containing diamine may be a reaction product of an aromatic diamine represented by Chemical Formula 1 and an aromatic dicarbonyl compound represented by Chemical Formula 2:

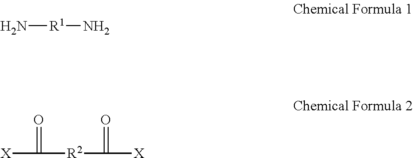

In Chemical Formula 1, R¹ includes a substituted or unsubstituted C6 to C30 aromatic organic group, wherein the aromatic organic group is present as a single ring; as a condensed ring system including two or more fused rings; or as a ring system including two or more aromatic rings linked together by a single bond or a functional group of a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

R¹ of Chemical Formula 1 may be substituted or unsubstituted two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof, wherein a substituent of the substituted ring system is selected from —OH, —CF₃, —CCl₃, —CBr₃, —Cl₃, —NO₂, —CN, —COCH₃, and —CO₂C₂H₅.

In an embodiment, R¹ of Chemical Formula 1 may be two or more phenylene groups linked together by a single bond and independently substituted with a substituent selected from —CF₃, —CCl₃, —CBr₃, —Cl₃, —NO₂, —CN, —COCH₃, and —CO₂C₂H₅.

In an embodiment, Chemical Formula 1 may be 2,2′-bis(trifluoromethyl)benzidine (TFDB).

In Chemical Formula 2, R² may be a substituted or unsubstituted phenylene group or biphenylene group, and X may be a halogen atom.

In Chemical Formula 2, R² may be unsubstituted phenylene group or biphenylene group and X may be Cl to be terephthaloyl dichloride (TPCL) or biphenyl dicarbonyl chloride (BPCl).

In an embodiment, Chemical Formula 2 may be terephthaloyl dichloride (TPCL).

According to an embodiment, an amine group of a first monomer (Chemical Formula 1) reacts with a carbonyl group of a second monomer (Chemical Formula 2) to form a diamine of aramid structure including an amide structural unit.

On the other hand, the aromatic dianhydride may be represented by Chemical Formula 3.

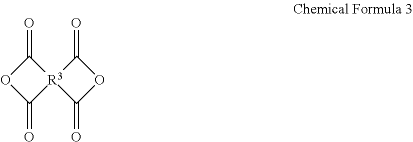

In Chemical Formula 3, R³ includes a substituted or unsubstituted C6 to C30 aromatic organic group, wherein the aromatic organic group is present as a single ring; as a condensed ring system including two or more fused rings; or as a ring system including two or more aromatic rings linked together by a single bond or a functional group selected from a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

R³ of Chemical Formula 3 may be substituted or unsubstituted two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof.

For example, Chemical Formula ₃ may be represented by Chemical Formula 4.

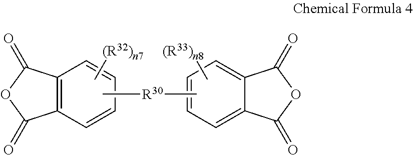

In Chemical Formula 4,

R³⁰ is a single bond, —O—, —S—, —C(═O)—, —CH(OH)—, —C(═O)NH—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein 1≤n≤10, 1≤p≤10, and 1≤q≤10) group,

R³² and R³³ are independently a halogen, a hydroxy group, a substituted or unsubstituted C1 to C10 aliphatic organic group, a substituted or unsubstituted C6 to C20 aromatic organic group, a —OR³⁰¹ group (wherein, R³⁰¹ is a C1 to C10 aliphatic organic group), or a —SiR³¹⁰R³¹¹R³¹² group (wherein R³¹⁰, R³¹¹, and R³¹² are independently hydrogen or a C1 to C10 aliphatic organic group), and

n7 and n8 are independently one of integers of 0 to 3.

The aromatic dianhydride represented by Chemical Formula 4 may be a combination of a compound, wherein R³⁰ is a single bond and n7 and n8 are each 0 and a compound, wherein R³⁰ is —C(CₙF₂ₙ₊₁)₂— (wherein, 1≤n≤10) and n7 and n8 are each 0.

In other words, the aromatic dianhydride represented by Chemical Formula 4 may be a combination of 2,2-bis-(3,4-dicarboxyphenyl)hexafluoropropane dianhydride (6FDA) and 3,3′,4,4′-biphenyltetracarboxylic dianhydride (BPDA).

In an embodiment, the polyimide-based film may be prepared by using TFDB as the aromatic diamine, TPCL as an aromatic dicarbonyl compound, and 6FDA and BPDA as the aromatic dianhydride, and may be particularly a poly(amide-imide) copolymer film.

The polyimide-based film may be prepared from a reaction product including the aromatic dicarbonyl compound represented by Chemical Formula 2 in an amount of greater than or equal to about 20 mol %, for example, greater than or equal to about 30 mol %, greater than or equal to about 40 mol %, greater than or equal to about 45 mol %, greater than or equal to about 50 mol %, and, for example, less than or equal to about 90 mol %, for example, less than or equal to about 80 mol %, less than or equal to about 75 mol %, less than or equal to about 70 mol %, based on a total amount of the dianhydride and the aromatic dicarbonyl compound. When the aromatic dicarbonyl compound represented by Chemical Formula 2 is used within the content range, the film may maintain hardness characteristics (surface hardness and indentation hardness) within an improved range.

In the polyimide-based film, the aromatic dianhydride represented by Chemical Formula 4 may include 6FDA in an amount of greater than or equal to about 5 mol %, for example, greater than or equal to about 10 mol %, greater than or equal to about 15 mol %, greater than or equal to about 20 mol %, or greater than or equal to about 25 mol %, and for example, less than or equal to about 45 mol %, for example, less than or equal to about 40 mol %, less than or equal to about 35 mol %, or less than or equal to about 30 mol %, based on a total amount of the dianhydride and the aromatic dicarbonyl compound.

When 6FDA as the aromatic dianhydride is included within the content range, the film may maintain improved hardness and also have improved optical characteristics such as yellowness and the like.

Another embodiment provides a composition for preparing the polyimide-based film, which includes amide structural unit-containing diamine represented by Chemical Formula 5 and dianhydride represented by Chemical Formula 4:

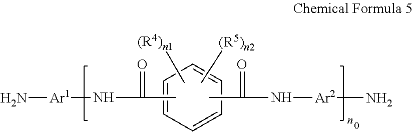

wherein, in Chemical Formula 5,

R⁴ and R⁵ are independently a halogen, a hydroxy group, a substituted or unsubstituted C1 to C10 alkyl group, or a substituted or unsubstituted C1 to C10 alkoxy group,

n0 is an integer of 1 or more,

n1 and n2 are independently an integer ranging from 0 to 4, provided that n1+n2 are is an integer of 0 to 4, and

Ar¹ and Ar² are independently represented by Chemical Formula 6:

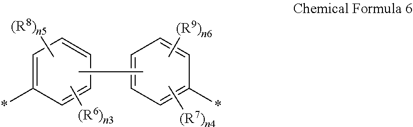

wherein, in Chemical Formula 6,

R⁶ and R⁷ are independently an electron withdrawing group selected from —CF₃, —CCl₃, —CBr₃, —Cl₃, —NO₂, —CN, —COCH₃, and —CO₂C₂H₅, R⁸ and R⁹ are the same or different and are independently a halogen, a hydroxy group, an alkoxy group (—OR³⁰⁴, wherein R³⁰⁴ is a C1 to C₁₀ aliphatic organic group), a silyl group (—SiR³⁰⁵R³⁰⁶R³⁰⁷, wherein R³⁰⁵, R³⁰⁶, and R³⁰⁷ are the same or different and are independently hydrogen, a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4;

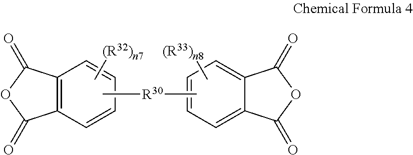

wherein, in Chemical Formula 4,

R³⁰ is a single bond, —O—, —S—, —C(═O)—, —CH(OH)—, —C(═O)NH—, —S(═O)₂—, —Si(CH₃)₂—, —(CH₂)ₚ— (wherein, 1 ≤p≤10), —(CF₂)_{q}— (wherein, 1 ≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein 1≤n≤10, 1≤p≤10, and 1≤q≤10) group,

R³² and R³³ are independently a halogen, a hydroxy group, a substituted or unsubstituted C1 to C10 aliphatic organic group, a substituted or unsubstituted C6 to C20 aromatic organic group, a —OR³⁰¹ group (wherein, R³⁰¹ is a C1 to C10 aliphatic organic group), or a —SiR³¹⁰R₃₁₁R³¹² group (wherein R³¹⁰, R³¹¹ and R³¹² are independently hydrogen or a C1 to C10 aliphatic organic group), and

n7 and n8 are independently one of integers of 0 to 3.

The composition may further include the aromatic diamine represented by Chemical Formula 7:

Chemical Formula 7

H₂N—Ar³—NH₂

In Chemical Formula 7, Ar³ is represented by Chemical Formula 6.

The aromatic dianhydride represented by Chemical Formula 4 may be a combination of a compound, wherein R³⁰ a single bond and n7 and n8 are each 0 and a compound, wherein R³⁰ is —C(CₙF₂ₙ₊₁)₂— (wherein, 1≤n≤10) and n7 and n8 are each 0.

That is, the aromatic dianhydride represented by Chemical Formula 4 may be a combination of 2,2-bis-(3,4-dicarboxyphenyl)hexafluoropropane dianhydride (6FDA) and 3,3′,4,4′-biphenyltetracarboxylic dianhydride (BPDA).

In Chemical Formula 5, the amide structural unit marked by n0 may be included in an amount of greater than or equal to about 20 mol %, for example, greater than or equal to about 30 mol %, greater than or equal to about 40 mol %, greater than or equal to about 45 mol %, or greater than or equal to about 50 mol %, and for example, less than or equal to about 90 mol %, for example, less than or equal to about 80 mol %, less than or equal to about 75 mol %, or less than or equal to about 70 mol %, based on a total sum of a mole number of the amide structural unit and a mole number of the aromatic dianhydride represented by Chemical Formula 4. When the amide structural unit marked by n0 in diamine represented by Chemical Formula 5 is used within the content range, hardness characteristics (surface hardness and indentation hardness) of a film formed of the composition may be maintained within the improved range.

The aromatic dianhydride represented by Chemical Formula 4 may include 6FDA in an amount of greater than or equal to about 5 mol %, for example, greater than or equal to about 10 mol %, greater than or equal to about 15 mol %, greater than or equal to about 20 mol %, or greater than or equal to about 25 mol %, and for example, less than or equal to about 45 mol %, less than or equal to about 40 mol %, less than or equal to about 35 mol %, or less than or equal to about 30 mol %, based on a total sum of a mole number of the amide structural unit marked by n0 and a mole number of the aromatic dianhydride the diamine represented by Chemical Formula 5.

While not wishing to be bound by theory, it is understood that when 6FDA as the aromatic dianhydride is included in the content range, optical characteristics such as yellowness of the film may be improved, but hardness of the film may also be maintained.

According to an embodiment, a polyimide-based film, for example, a poly(amide-imide) copolymer film may be formed by polymerizing amide structural unit-containing diamine including the aromatic dicarbonyl compound and an aromatic diamine in a mole ratio of about 1:1 with an aromatic dianhydride by a well-known method. Accordingly, the poly(amide-imide) copolymer film according to an embodiment may be made in a much higher yield without a tedious precipitation process. This will be illustrated as follows.

In general, a poly(amide-imide) copolymer may be prepared by reacting a diacyl halide compound such as dicarboxylic acid chloride with diamine to form an amide structural unit, adding additional diamine and dianhydride thereto to form an amic acid structural unit from the diamine and the dianhydride and simultaneously, to link the amide structural unit with the amic acid structural unit. On the other hand, a halogenated hydrogen (HX: X is a halogen) side reaction product such as HCl may be produced during formation of the amide structural unit and corrode an equipment, which needs to be removed by adding a HX scavenger such as tertiary amine to form a HX salt (refer to Reaction Scheme 1). In this regard, when a film is formed without additionally removing the HX salt, optical characteristics of the film may be seriously deteriorated. Accordingly, a conventional method of preparing the poly(amide-imide) copolymer necessarily requires the additional precipitation process of removing the HX salt, which increases the entire process time and cost, and also decreases a yield of the poly(amide-imide) copolymer.

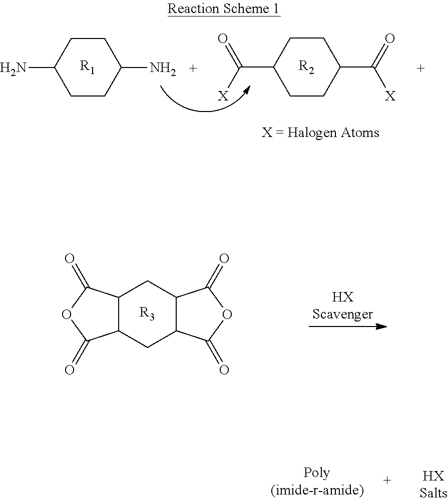

On the other hand, when a composition including amide structural unit-containing oligomeric diamine and dianhydride, according to the embodiment, is used, the precipitation process of removing an HX salt used in the conventional method of preparing a poly(amide-imide) copolymer may be omitted. Accordingly, the final yield of the poly(amide-imide) copolymer may be increased, while decreasing the entire process time and cost. In addition, since the amide structural unit is included in a larger amount in the poly(amide-imide) copolymer than the amide structural unit obtained by the conventional method, mechanical characteristics of a molded article, for example, a film formed of the composition may be further improved or maintained without deteriorating optical characteristics.

Herein, the amide structural unit-containing and oligomeric diamine represented by Chemical Formula 5 may be prepared in a well-known method of reacting diamine with a dicarbonyl derivative, for example, a well-known method of preparing polyamide such as a low temperature solution polymerization method, an interface polymerization method, a melt polymerization method, a solid-phase polymerization method, and the like. The low temperature solution polymerization method may be performed by reacting a diamine compound forming an amide structural unit with a diacyl halide compound in an aprotic polar solvent, that is, adding the diamine compound in an excessive amount to the diacyl halide compound so that both terminal ends have an amino group. This amide structural unit-containing diamine as a diamine monomer may be reacted with dianhydride represented by Chemical Formula 4 to easily prepare a poly(amide-imide) copolymer including an amide structural unit and an imide structural unit.

In other words, the composition for preparing a polyimide-based film according to the embodiment needs no precipitation process for removing a side reaction product, HCl, generated during formation of the amide structural unit. In addition, it may increase an amount of the amide structural unit in a polyimide-based film, and thus, improve hardness characteristics of the polyimide-based film. After forming a poly(amide-imide) copolymer from the composition, a well-known method of dry/wet, dry, wet, and the like may be adopted. For example, when the dry/wet method is used to form a film, the film may be formed by extruding a solution including the composition on a support such as a drum, an endless belt, and the like and then, drying the solution by evaporating a solvent from the film until the film has self-maintenance. The drying may be performed by increasing a temperature from room temperature, for example, about 25° C. to about 130° C. within about 1 hour. Then, the dried film is heated at a speed of about 10 degree Centigrade per minute (°C./min) from about 250° C. to about 300° C. for about 5 minutes to about 30 minutes to obtain a polyimide-based film.

When the drum and the endless belt have a flat surface during the drying, a flat film may be obtained. The dried film may be delaminated from the support and introduced into a wet process to remove a salt, a solvent, and the like, and in addition, elongated, dried, heat-treated, and the like to obtain a final film.

The heat treatment may be performed at about 200° C. to about 300° C., for example, at about 250° C. for several minutes.

The heat-treated film may be slowly cooled down, for example, at a speed of less than or equal to about 50 degrees Centigrade per second (°C./sec).

The film may have a single layer or more than one layer.

The film may have Martens hardness of greater than or equal to about 10 N/mm², for example, greater than or equal to about 11 N/mm², for example, greater than or equal to about 12 N/mm², for example, greater than or equal to about 13 N/mm², for example, greater than or equal to about 14 N/mm², for example, greater than or equal to about 15 N/mm², and for example, greater than or equal to about 16 N/mm² but for example, less than or equal to about 150 N/mm², for example, less than or equal to about 140 N/mm², for example, less than or equal to 130 N/mm², and for example, less than or equal to 120 N/mm² at a thickness of about 30 μm to about 100 μm.

According to another embodiment, a method of measuring an indentation hardness of the polyimide-based film is provided.

In general, indentation hardness of a transparent plastic film is difficult to directly measure due to its characteristics of having a thickness of less than or equal to tens of millimeters, less than or equal to several millimeters, or several to hundreds of micrometers.

Accordingly, the present inventors have made an attempt to develop a method of easily measuring hardness of the above polyimide-based film and as a result, discovered a method of directly estimating indentation hardness of the polyimide-based film by manufacturing a laminate specimen including the polyimide-based film, indenting the polyimide-based film on the laminate specimen with an indenter to measure a force applied to the laminate and an indentation depth of the laminate.

Accordingly, another embodiment provides an indentation hardness estimating method of a polyimide-based film, the method including: preparing a laminate including a substrate, an adhesion layer disposed on the substrate, and the polyimide-based film disposed on the adhesion layer, measuring a pressure applied to the laminate and an indentation depth of the laminate while indenting the laminate using an indenter, and

estimating an indentation hardness of the polyimide-based film using the measured force applied to the laminate and the indentation depth of the laminate.

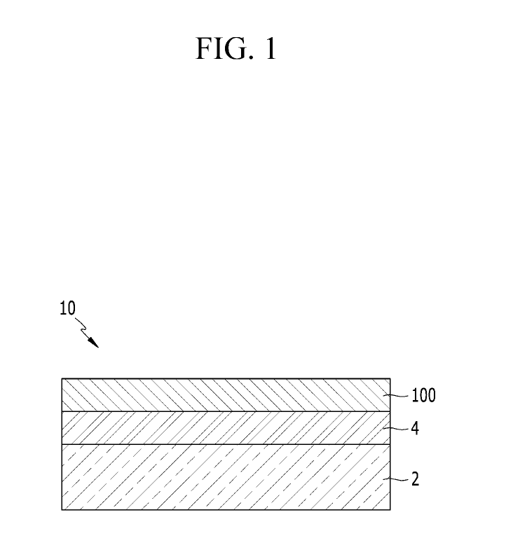

Hereinafter, referring to FIGS. 1 to 5, a method of estimating the indentation hardness of the polyimide-based film according to another embodiment is illustrated.

FIG. 1 is a schematic view showing a laminate including a polyimide-based film according to an embodiment.

First, a laminate 10 is prepared by laminating a substrate 2, an adhesion layer 4, and a polyimide-based film 100 in order.

The substrate 2 may be formed of a transparent or opaque material having predetermined hardness. In an embodiment, the substrate 2 may be formed of any material having enough hardness to receiving no influence despite a force on the adhesion layer 4 and the polyimide-based film 100, for example, a material such as glass, plastic, and the like.

The adhesion layer 4 is formed on the substrate 2 and may play a role of fixing the substrate 2 with the polyimide-based film 100. The adhesion layer 4 may be formed of a flexible material. The adhesion layer 4 may be indented along with the polyimide-based film 100 and thus elastically or plastically transformed when a force is applied to the polyimide-based film 100.

The adhesion layer 4 may have no particular limit in terms of a thickness but any thickness, as far as an indenter may not directly contact the upper surface of the substrate 2 when a pressure is applied on the polyimide-based film 100.

The adhesion layer 4 may have no particular limit, but may be formed of any material capable of securing sufficient adhesion strength enough to prevent the adhesion layer 4 from being peeled off the substrate 2 or from the polyimide-based film 100 around a place where a pressure is applied to the polyimide-based film 100.

The polyimide-based film 100 has the composition. The polyimide-based film 100 may have a thickness within various ranges depending on a use, an environment, and the like. The polyimide-based film 100 may have a thickness of less than or equal to about tens of millimeters or several to hundreds of micrometers. In other words, the polyimide-based film 100 may have a commonly-used thickness or be thinner or thicker than the common one.

Each thickness of the polyimide-based film 100, the adhesion layer 4, and the substrate 2 has no particular limit, but the thickness of the substrate 2 may be greater than that of the polyimide-based film 100 or the adhesion layer 4 in order to measure hardness of the laminate 10 under a strong pressure.

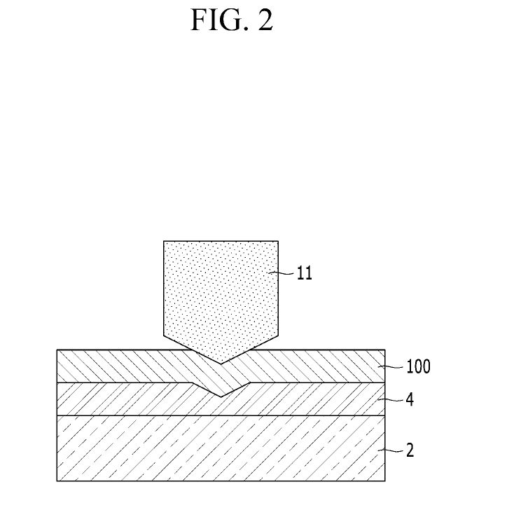

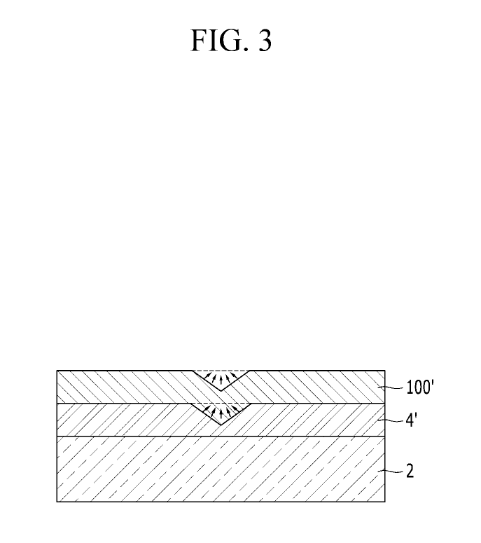

FIGS. 2 and 3 are schematic views showing the laminate of FIG. 1 when indented up to less than or equal to an elastic limit.

Hereinafter, the upper surface of the laminate 10 is pressed with the indenter 11, as shown in FIG. 2. The polyimide-based film 100 and the adhesion layer 4 may be respectively indented up to a predetermined depth as shown in FIG. 2, but the substrate 2 is not deformed but maintains its original shape.

Indentation time by the indenter 11 has no particular limit but may be appropriately controlled, so that the polyimide-based film 100 and/or the adhesion layer 4 may not be crept by the indenter 11.

Subsequently, an indentation depth of the laminate 10 and a force applied thereto through the indenter 11 are respectively measured with a reference to a place where the laminate 10 is the most deeply indented by the indenter 11.

The indentation depth of the laminate 10 may be equal to or thinner than a thickness sum of the polyimide-based film 100 and the adhesion layer 4.

On the other hand, when the polyimide-based film 100 is indented up to less than or equal to an elastic limit, the indentation depth of the laminate 10 may have various thickness values depending on a thickness of the polyimide-based film 100, its internal composition ratio, and the like, and may be less than or equal to that of the polyimide-based film 100, as shown in FIG. 2. In addition, as shown in FIG. 3, when the indentation is complete, the polyimide-based film 100 and the adhesion layer 4 may exhibit an elastic behavior of being recovered to an initial state.

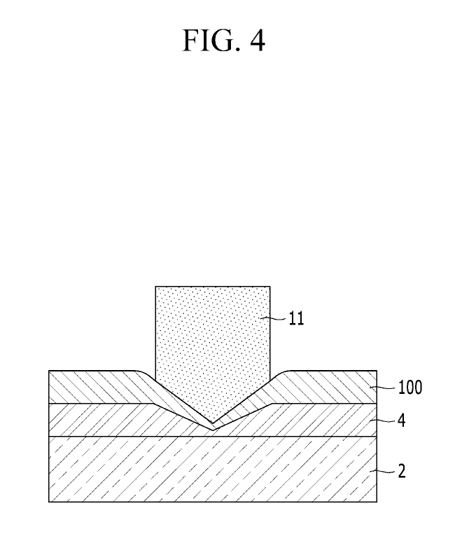

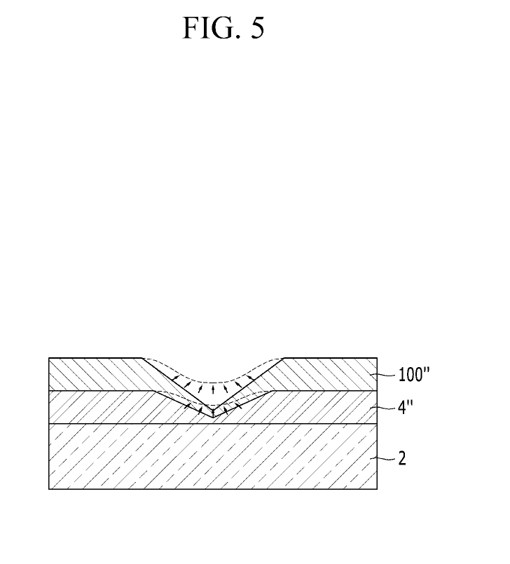

FIGS. 4 and 5 are schematic views showing a case that the laminate of FIG. 1 is indented up to greater than an elastic limit of the polyimide-based film.

On the other hand, the indentation may be performed up to greater than an elastic limit of the polyimide-based film 100. Herein, an indentation depth of the laminate 10 may be different depending on a thickness of the polyimide-based film 100, its internal composition ratio, and the like but greater than or equal to a thickness of the polyimide-based film 100 as shown in FIG. 4. In other words, a force on the polyimide-based film 100 may be increased, until an indentation depth of the polyimide-based film 100 is greater than or equal to than a thickness thereof. Accordingly, as shown in FIG. 5, when the indentation is complete, the polyimide-based film 100 and the adhesion layer 4 may exhibit a plastic deformation behavior.

The force on the laminate 10 may be variously set depending on a force applied to the indenter 11, and the force applied to the indenter 11 may not be large enough to deform or break the substrate 2.

Then, indentation hardness of the polyimide-based film 100 may be estimated by using the indentation depth of the laminate 10 and the force applied on the laminate 10.

In detail, Martens hardness of the polyimide-based film 100 is obtained by dividing the force applied on the laminate 10 by an indented surface area of the laminate 10 by the indenter 11.

The Martens hardness (HM) may be expressed as follows.

$$HM = \frac{F}{{A}_{S} ( h )} = \frac{F}{k \times {h}^{2}} \qquad Equation 1$$

In Equation 1, F indicates a force applied to the laminate 10, h indicates an indentation depth of the laminate 10, k indicates a constant depending on a kind of the indenter 11, and Aₛ(h) indicates an indented surface area of the laminate 10 by the indenter 11. In other words, the indented surface area of the laminate 10 by the indenter 11 may be expressed as a variable relative to the indentation depth h of the indenter 11.

When the indenter 11 is a Vickers indenter, k may be expressed by Equation 2.

$$k = 4 \times \frac{sin ( \frac{α}{2} )}{{cos}^{2} ( \frac{α}{2} )} \qquad Equation 2$$

In Equation 2, a indicates an angle of edges of the indenter.

Herein, when the indenter 11 is a Vickers Diamond Pyramid indenter whose edges form an angle of 136°, k is about 26.44.

According to an embodiment, the estimation method may be used to measure indentation hardness of the polyimide-based film. According to this estimation method, the polyimide-based film may have Martens hardness of greater than or equal to about 10 N/mm², for example, greater than or equal to about 11 N/mm², for example, greater than or equal to about 12 N/mm², for example, greater than or equal to about 13 N/mm², for example, greater than or equal to about 14 N/mm², for example, greater than or equal to about 15 N/mm², and for example, greater than or equal to about 16 N/mm² but, for example, less than or equal to about 150 N/mm², for example, less than or equal to about 140 N/mm², for example, less than or equal to about 130 N/mm², and for example, less than or equal to about 120 N/mm² under a thickness condition of about 30 μm to about 100 μm as described above.

Other than the estimation method of an embodiment, various indentation hardness-measuring methods may be used to measure indentation hardness of the polyimide-based film. However, when Martens hardness of a polyimide-based film is measured under aforementioned estimation condition, and the polyimide-based film has Martens hardness within the aforementioned range of the polyimide-based film 100, the polyimide-based film may be regarded to belong to a range of the polyimide-based film according to an embodiment.

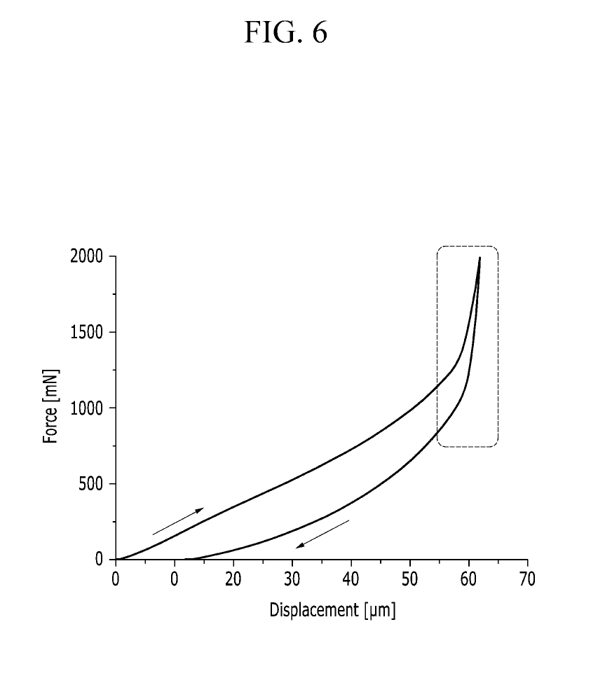

Hereinafter, an elastic-plastic deformation behavior of the laminate is illustrated according to a method of estimating indentation hardness of the polyimide-based film referring to FIG. 6.

FIG. 6 is a graph showing relationship between an indentation depth (an x-axis, displacement) the laminate of FIG. 1 and a force (a y-axis) applied thereto.

In FIG. 6, the laminate consists of a glass substrate, a 50 micrometer-thick adhesion layer (OCA 8146-2, 3M), and a 50 micrometer-thick polyimide-based film including TPCL, 6FDA, BPDA, and TFDB in a mole ratio of 50:28:22:100, and the indenter 11 is a Vickers diamond pyramid indenter having an edge angle of 136°, and a load ranging from about 0 mN to about 2,000 mN is applied to the laminate 10 through the indenter 11.

Referring to FIG. 6, the indentation depth tends to be approximately proportional to the force applied to the laminate up to a section that the indentation depth is a little beyond the thickness (50 micrometers) of the polyimide-based film. In other words, in the section, the polyimide-based film shows an elastic deformation behavior as shown in FIG. 3.

However, as the indentation depth reaches a dotted line area beyond the thickness of the polyimide-based film, the force applied to the laminate tends to much increase relative to the indentation depth. In other words, in the dotted line section, even though the force applied to the laminate is decreased, the polyimide-based film exhibits a plastic deformation behavior as shown in FIG. 5.

In other words, FIG. 6 simultaneously shows an indentation hardness of the polyimide-based film having a thickness of 50 micrometers and its critical point starting to show a plastic deformation behavior.

Another embodiment provides a display device including the polyimide-based film according to an embodiment. As mentioned above, the film has improved indentation hardness, and thus, may be used as a window film for a display device, particularly, a flexible display device and the like.

Hereinbefore, a poly(amide-imide) copolymer prepared by using a composition according to an embodiment has appropriate optical characteristics for a window film and the like and simultaneously, improved indentation hardness, and thus, may be appropriately used for a window film for a flexible display device and the like.

In addition, the indentation hardness estimation method may be used to simply estimate indentation hardness of a film having a thickness of a micro to millimeter range and to obtain a critical point showing a plastic deformation behavior of the film depending on a thickness and thus to digitize indentation hardness and a mechanical behavior of a polyimide-based film having various thicknesses and compositions.

Hereinafter, the embodiments are described with reference to examples and comparative examples. The following examples and comparative examples are exemplary but do not limit the scope of the present disclosure.

### EXAMPLES

### Synthesis Example 1

### Amide Structural Unit-containing Oligomeric Diamine

An oligomeric diamine containing an amide structural unit, in which TFDB at both ends of TPCL are bonded to form an aramid structure according to Reaction Scheme 2 is prepared:

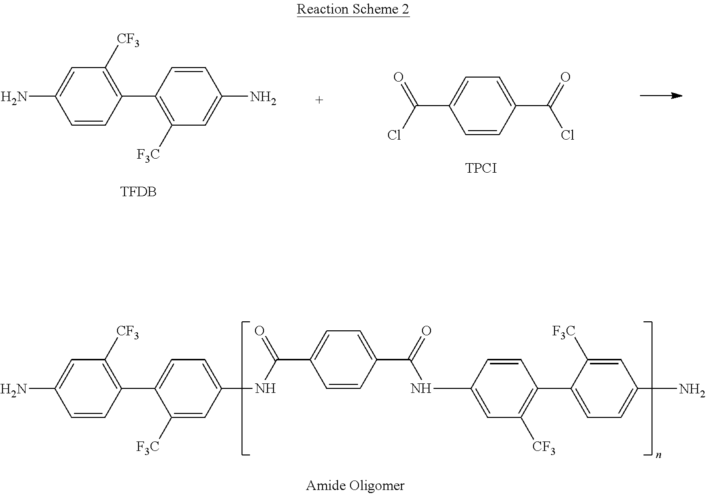

According to the procedure, 1 mole equivalent (0.109 mol, 35 g) of 2,2′-bis(trifluoromethyl)benzidine (TFDB) and 2.8 mole equivalent (0.306 mol, 24.21 g) of pyridine are dissolved in 700 g of N,N-dimethyl acetamide as a solvent in a reactor, and 50 g of DMAC is added thereto to completely dissolve the remaining TFDB. Subsequently, 0.7 mole equivalent (0.077 mol, 15.53 g) of TPCL (terephthaloyl dichloride, 1,4-benzenedicarbonyl chloride), divided into four portions, separately added to the TFDB solution, and the obtained mixture is vigorously stirred for 15 minutes.

The resulting solution is stirred under a nitrogen atmosphere for 2 hours and added to 7 L of a NaCl solution containing 350 g of NaCl, and the obtained mixture is stirred for 10 minutes. A solid produced therein is filtered, twice washed, resuspended, and refiltered with 5 L of deionized water. A final filtrate on a filter is thoroughly pressed to remove most of the water remaining there, and dried at 90° C. under vacuum for 48 hours to obtain the oligomeric diamine containing 70 mol % of an amide structural unit as a product described in Reaction Scheme 2.

### Synthesis Example 2

### Amide Structural Unit-containing Oligomeric Diamine

An oligomeric diamine containing an amide structural unit of 50 mol % is prepared according to the same method as Synthesis Example 1 except for using 700 g of N,N-dimethyl acetamide, 1 mole equivalent (0.109 mol, 35 g) of TFDB, 2 mole equivalent (0.219 mol, 17.29 g) of pyridine, and 0.5 mole equivalent (0.055 mol, 11.09 g) of TPCL.

### Example and Comparative Example: Manufacture of Polyimide-Based Film

### Example 1

165.30 g of dimethyl acetamide (DMAc) is placed in a 250 ml 4-necked double wall reactor equipped with a mechanical agitator and a nitrogen inlet while nitrogen is passed and set at 25° C., 25 g (0.018 mol) of the oligomeric diamine containing 70 mol % of an amide structural unit according to Synthesis Example 1 is dissolved therein, and the solution is maintained at 25° C. Then, 2.58 g (0.009 mol) of BPDA and 3.90 g (0.009 mol) of 6FDA are stirred for 48 hours, 4.23 g of pyridine and 5.46 g of acetic anhydride are added thereto, and the obtained mixture is stirred for 24 hours to obtain a poly(amide-amic acid) solution.

When a reaction is complete, the obtained solution is coated on a glass plate and dried on a 130° C. hot plate for 40 minutes. Then, a film formed thereon is detached from the glass plate and placed in a furnace, heated from room temperature up to 250° C. at 10° C./min, maintained at 250° C. for about 30 minutes, and slowly cooled down to obtain a poly(amide-imide) copolymer film according to Example 1.

The poly(amide-imide)copolymer film includes TPCL, 6FDA, BPDA, and TFDB in a mole ratio of 70:15:15:100 and has a thickness of 40 micrometer.

### Example 2

A poly(amide-imide)copolymer film according to Example 2 is obtained through the same process as Example 1, except that the film has a thickness of 46 micrometer.

### Example 3

A poly(amide-imide)copolymer film according to Example 3 is obtained through the same process as Example 1, except that the film has a thickness of 70 micrometer.

### Example 4

A poly(amide-imide)copolymer film according to Example 4 is obtained through the same process as Example 1, except that the film has a thickness of 80 micrometer.

### Example 5

A poly(amide-imide)copolymer film according to Example 5 is obtained through the same process as Example 1, except for using an oligomeric diamine containing 50 mol % of an amide structural unit according to Synthesis Example 2, mixing each compound to have a mole ratio of TPCL, 6FDA, BPDA, TFDB =50:27:23:100, and except that the film has a thickness of 50 micrometer.

### Example 6

A poly(amide-imide)copolymer film according to Example 6 is obtained through the same process as Example 5, except for using an oligomeric diamine containing 50 mol % of an amide structural unit according to Synthesis Example 2 and mixing each compound to have a mole ratio of TPCL, 6FDA, BPDA, TFDB=50:28:22:100.

### Example 7

A poly(amide-imide)copolymer film according to Example 7 is obtained through the same process as Example 1, except that the film has a thickness of 80 micrometer.

### Example 8

A poly(amide-imide)copolymer film according to Example 8 is obtained through the same process as Example 1 except for mixing each compound to have a mole ratio of TPCL, 6FDA, BPDA, TFDB=70:13:17:100, and that a film has a thickens of 50 micrometer.

### Comparative Example 1

301.03 g of N,N-dimethyl acetamide (DMAc) is filled in a 500 mL reactor equipped with an agitator, a nitrogen injector, and a cooler while nitrogen is passed, after setting the reactor at 25° C., 25 g (0.078 mol) of TFDB is dissolved therein, and the solution is maintained at 25° C. Subsequently, 4.59 g (0.016 mol) of BPDA and 27.75 g (0.063 mol) of 6FDA are added thereto, the obtained mixture is stirred for 48 hours, 18.53 g of pyridine and 23.91 g of acetic anhydride are added thereto, and the obtained mixture is stirred for 24 hours to obtain a polyamic acid solution.

When a reaction is complete, the obtained solution is coated on a glass plate and dried on a 130° C. hot plate for 40 minutes. Then, a film formed thereon is peeled off the glass plate and then, placed in a furnace, heated from room temperature to 250° C. at 10° C./min, maintained at 250° C. for about 30 minutes, and slowly cooled down to obtain a polyimide-based film according to

### Comparative Example 1.

The polyamide film included 6FDA, BPDA, and TFDB in a mole ratio of 80:20:100 and has a thickness of 80 micrometer.

### Comparative Example 2

A polyamide film according to Comparative Example 2 is obtained through the same process as Comparative Example 1, except that the thickness of the film is 50 micrometer. Manufacture of Laminates according to Examples and Comparative Examples

Each laminate according to examples to comparative examples is completed by forming a 50 micrometer-thick adhesion layer (OCA 8146-2, 3M) on a glass substrate, and then, respectively attaching the poly(amide-imide)copolymer films according to Examples or the polyimide-based films according to Comparative Examples.

Evaluation 1: Indentation Hardness of Film depending on Thickness

Indentation hardness of the laminates respectively loaded with the poly(amide-imide) copolymer film according to Examples 1 to 4 and with the polyimide-based film according to Comparative Example 1 depending on a film thickness is measured, and the results are shown in Table 1.

The indentation hardness of the films is measured and calculated by using a Martens hardness evaluation method according to the above another embodiment, and herein, an indentation depth and Martens hardness about each case that the films are pressed with a force of 2,000 mN under no creep condition for 20 seconds (a compression condition 1) and with a force of 300 mN under no creep condition for 20 seconds (a compression condition 2) are obtained.

TABLE 1

| | | Experiment | | Experiment | |
|---|---|---|---|---|---|
| | Thickness | condition 1 | | condition 2 | |
| | of | Martens | Indentation | Martens | Indentation |
| | polyimide | hardness | depth | hardness | depth |
| | film (μm) | (N/mm²) | (μm) | (N/mm²) | (μm) |
| Example 1 | 40 | 18.5 | 62.8 | 31.0 | 18.9 |
| Example 2 | 46 | 18.5 | 62.8 | 43.4 | 16.0 |
| Example 3 | 70 | 31.1 | 48.5 | 101.5 | 10.4 |
| Example 4 | 80 | 38.7 | 43.4 | 115.4 | 9.8 |
| Comparative | 80 | 29.5 | 49.7 | 103.9 | 10.3 |
| Example 1 | | | | | |

Referring to Table 1, Martens hardness increases under both of the experiment conditions 1 and 2 as a thickness of the films according to Examples 1 to 4 is increased, but the indentation depth tends to be decreased.

On the other hand, the film of Comparative Example 1 shows a deeper indentation depth and smaller Martens hardness than the film of Example 4. The reason is that the film of Comparative Example 1 includes no amide structural unit unlike that of Example 4.

Evaluation 2: Indentation Hardness and Surface Hardness of Film depending on Composition

Indentation hardness of the laminates respectively loaded with the poly(amide-imide) copolymer film according to Examples 5 to 8 and with the polyimide-based film according to Comparative Example 2 depending on a composition of the films is estimated, and the results are shown in Table 2.

The indentation hardness of the films is measured and calculated in the Martens hardness measurement method according to another embodiment each case that the films are pressed with a force of 2000 mN under no creep condition for 20 seconds (Compression condition 1) and with a force of 300 mN under no creep condition for 20 seconds (Compression condition 2).

Surface hardness of the films is obtained by measuring pencil hardness under a load of 1 kgf according to ASTM D3363.

TABLE 2

| | | Experiment | | Experiment | | |
|---|---|---|---|---|---|---|
| | | condition 1 | | condition 2 | | |
| | | Martens | Indentation | Martens | Indentation | |
| | TPCL:6FDA:BPDA:TFDB | hardness | depth | hardness | depth | Surface |
| | (mole ratio) | (N/mm²) | (μm) | (N/mm²) | (μm) | hardness |
| Example 5 | 50:27:23:100 | 18.8 | 62.4 | 40.6 | 16.5 | 4B |
| Example 6 | 50:28:22:100 | 18.9 | 62.1 | 40.6 | 16.5 | 4B |
| Example 7 | 70:15:15:100 | 19.5 | 61.3 | 56.2 | 13.9 | HB |
| Example 8 | 70:13:17:100 | 20 | 60.5 | 56.7 | 13.9 | 3H |
| Comparative | 0:80:20:100 | 17.6 | 64.3 | 36.1 | 17.5 | 6B |
| Example 2 | | | | | | |

Referring to Table 2, the films of Examples 5 to 8 show increased Martens hardness but a decreased indentation depth under the experiment conditions 1 and 2. In addition, the films of Examples 5 to 8 show gradually increased surface hardness.

The reason is that the films of Examples 7 and 8 include TPCL in a larger amount, and thus, an amide structural unit in a higher mole ratio than the films of Examples 5 and 6, and the film of Example 8 includes a larger amount of BPDA, and thus, a somewhat improved surface hardness compared with the film of Example 7.

On the other hand, the film of Comparative Example 2 shows a deeper indentation depth and smaller Martens hardness than the films of Examples 5 to 8. The reason is that the film of Comparative Example 2 includes no amide structural unit unlike the films of Examples 5 to 8.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polyimide film, which is a reaction product of a diamine comprising an amide structural unit in an amount of greater than about 0 mole percent and less than or equal to about 80 mole percent and an aromatic dianhydride, wherein the polyimide film has a Martens hardness of about 14 Newtons per square millimeter to about 120 Newtons per square millimeter at a thickness of about 30 micrometers to about 100 micrometers.

2. The polyimide film of claim 1, wherein the diamine is a reaction product of an aromatic diamine represented by Chemical Formula 1 and an aromatic dicarbonyl compound represented by Chemical Formula 2: 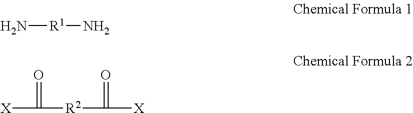
wherein, in Chemical Formula 1, R¹ comprises a substituted or unsubstituted C6 to C30 aromatic organic group, wherein the aromatic organic group is present as a single ring; as a condensed ring system comprising two or more fused rings; or as a ring system comprising two or more aromatic rings linked together by a single bond or a functional group selected from a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof, and
wherein, in Chemical Formula 2, R² is a substituted or unsubstituted phenylene group or a biphenylene group, and X is a halogen atom.

3. The polyimide film of claim 2, wherein R¹ of Chemical Formula 1 is substituted or unsubstituted ring system comprising two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, and a combination thereof, wherein a substituent of the substituted ring system is selected from —OH, —CF₃, —CCl₃, —CBr₃, —Cl₃, —NO₂, —CN, —COCH₃, and —CO₂C₂H₅.

4. The polyimide film of claim 2, wherein R¹ of Chemical Formula 1 is a ring system comprising two or more phenylene groups linked together by a single bond and independently substituted with a substituent selected from —CF₃, —CCl₃, —CBr₃, —Cl₃, —NO₂, —CN, —COCH₃, and —CO₂C₂H₅.

5. The polyimide film of claim 2, wherein R² of Chemical Formula 2 is an unsubstituted phenylene group, and X is Cl.

6. The polyimide film of claim 2, wherein the aromatic dianhydride is represented by Chemical Formula 3: 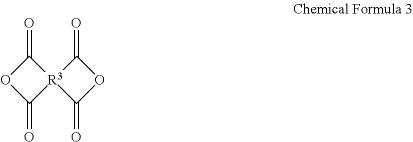
wherein, in Chemical Formula 3, R³ comprises a substituted or unsubstituted C6 to C30 aromatic organic group, wherein the aromatic organic group is present as a single ring; as a condensed ring system comprising two or more fused rings; or as a ring system comprising two or more aromatic rings linked together by a single bond or a functional group selected from a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1 ≤p≤10), —(CF₂)_{q}— (wherein, 1≤q≤10), —C(CH₃)₂—, —C(CF₃)₂—, —C(═O)NH—, and a combination thereof.

7. The polyimide film of claim 6, wherein R³ of Chemical Formula ₃ is substituted or unsubstituted ring system comprising two or more aromatic rings linked together by a single bond or a functional group selected from —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1q≤10), —C(CH₃)₂—, —C(CF₃)₂—, —C(═O)NH—, and a combination thereof.

8. The polyimide film of claim 6, wherein Chemical Formula ₃ is represented by Chemical Formula 4: 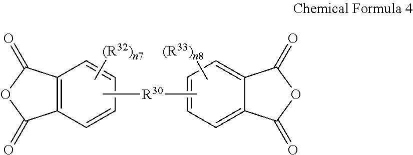
wherein, in Chemical Formula 4,
R³⁰ is a single bond, —O—, —S—, —C(═O)—, —CH(OH)—, —C(═O)NH—, —S(═O)₂—, —Si(CH₃)₂—, —(CH₂)ₚ— (wherein, 1 ≤p≤10), —(CF₂)_{q}— (wherein, 1 ≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}—(wherein 1≤n≤10, 1 ≤p≤10, and 1≤q≤10) group,
R³² and R³³ are independently a halogen, a hydroxy group, a substituted or unsubstituted C1 to C10 aliphatic organic group, a substituted or unsubstituted C6 to C20 aromatic organic group, a —OR³⁰¹ group (wherein, R³⁰¹ is a C1 to C10 aliphatic organic group), or a —SiR³¹⁰R³¹¹R³¹² group (wherein R³¹⁰, R³¹¹, and R³¹² are independently hydrogen or a C1 to C10 aliphatic organic group), and
n7 and n8 are independently one of integers of 0 to 3.

9. The polyimide film of claim 8, wherein the aromatic dianhydride represented by Chemical Formula 4 is a combination of a compound, wherein R³⁰ is a single bond and n7 and n8 are each 0 and a compound, wherein R³⁰ is —C(CₙF₂ₙ₊₁)₂— (wherein, 1≤n≤10) and n7 and n8 are each 0.

10. The polyimide film of claim 8, wherein the polyimide film is prepared from a reaction product comprising about 40 mole percent to about 80 mole percent of the aromatic dicarbonyl compound represented by Chemical Formula 2, based on a total amount of the dianhydride and the aromatic dicarbonyl compound.

11. The polyimide film of claim 8, wherein the aromatic dianhydride represented by Chemical Formula 4 comprises about 10 mole percent to about 30 mole percent of 6FDA, based on a total amount of the dianhydride and the aromatic dicarbonyl compound.

12. A composition for preparing a polyimide film, comprising a diamine represented by Chemical Formula 5 and dianhydride represented by Chemical Formula 4: 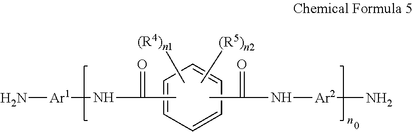
wherein, in Chemical Formula 5,
R⁴ and R⁵ are independently a halogen, a hydroxy group, a substituted or unsubstituted C1 to C10 alkyl group, or a substituted or unsubstituted C1 to C10 alkoxy group, and
n0 is an integer of 1 or more,
n1 and n2 are independently an integer ranging from 0 to 4, provided that n1+n2 is an integer of 0 to 4, and
Ar¹ and Ar² are independently represented by Chemical Formula 6: 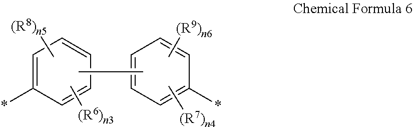
wherein, in Chemical Formula 6,
R⁶ and R⁷ are independently an electron withdrawing group selected from —CF₃, —CCl₃, —CBr₃, —Cl₃, —NO₂, —CN, —COCH₃, and —CO₂C₂H₅,
R⁸ and R⁹ are the same or different and are independently a halogen, a hydroxy group, an alkoxy group (—OR³⁰⁴, wherein R³⁰⁴ is a C1 to C10 aliphatic organic group), a silyl group (—SiR³⁰⁵, R³⁰⁶R³⁰⁷e, wherein R³⁰⁵, R³⁰⁶, and R³⁰⁷ are the same or different and are independently hydrogen, a C1 to C10 aliphatic organic group), a substituted or unsubstituted C1 to C10 aliphatic organic group, or a C6 to C20 aromatic organic group,
n3 is an integer ranging from 1 to 4, n5 is an integer ranging from 0 to 3, provided that n3+n5 is an integer ranging from 1 to 4, and
n4 is an integer ranging from 1 to 4, n6 is an integer ranging from 0 to 3, provided that n4+n6 is an integer ranging from 1 to 4, 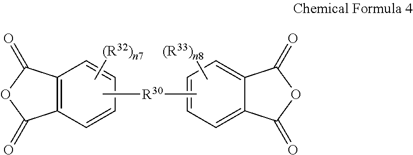
wherein, in Chemical Formula 4,
R³⁰ is a single bond, —O—, —S—, —C(═O)—, —CH(OH)—, —C(═O)NH—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein 1≤n≤10, 1≤p≤10, and 1≤q≤10) group,
R³² and R³³ are independently a halogen, a hydroxy group, a substituted or unsubstituted C1 to C10 aliphatic organic group, a substituted or to unsubstituted C6 to C20 aromatic organic group, a —OR³⁰¹ group (wherein, R³⁰¹ is a C1 to C10 aliphatic organic group), or a —SiR³¹⁰R³¹¹R³¹² (wherein R³⁰¹, R³¹¹, and R³¹² are independently hydrogen or a C1 to C10 aliphatic organic group) group, and
n7 and n8 are independently one of integers of 0 to 3.

13. The composition for preparing a polyimide film of claim 12, further comprising an aromatic diamine represented by Chemical Formula 7:
Chemical Formula 7
H₂N−Ar³−NH₂
wherein, in Chemical Formula 7, Ar³ is represented by Chemical Formula 6: 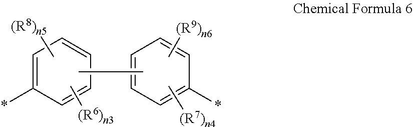
wherein, in Chemical Formula 6,
R⁶ and R⁷ are independently an electron withdrawing group selected from —CF₃, —CCl₃, —CBr₃, —Cl₃, —NO₂, —CN, —COCH₃, and —CO₂C₂H₅,
R⁸ and R⁹ are the same or different and are independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶, and R²⁰⁷ are the same or different and are independently hydrogen, a C1 to C10 aliphatic organic group), a substituted or unsubstituted C1 to C10 aliphatic organic group, or a C6 to C20 aromatic organic group,
n3 is an integer ranging from 1 to 4, n5 is an integer ranging from 0 to 3, provided that n3+n5 is an integer ranging from 1 to 4, and
n4 is an integer ranging from 1 to 4, n6 is an integer ranging from 0 to 3, provided that n4+n6 is an integer ranging from 1 to 4.

14. The composition for preparing a polyimide film of claim 12, wherein in Chemical Formula 5, an amount of the amide structural unit denoted by n0 is about 40 mole percent to about 80 mole percent, based on a total sum of a mole number of the amide structural unit and a mole number of the aromatic dianhydride represented by Chemical Formula 4.

15. The composition for preparing a polyimide film of claim 12, wherein an amount of the aromatic dianhydride represented by Chemical Formula 4 is about 10 mole percent to about 30 mole percent 6FDA, based on a total sum of a mole number of the amide structural unit denoted by n0 and a mole number of the aromatic dianhydride in the diamine represented by Chemical Formula 5.

16. A display device comprising the polyimide film of claim 1.

17. An indentation hardness estimating method of a polyimide film, which is a method of measuring an indentation hardness of the polyimide film of claim 1, the method comprising:
preparing a laminate comprising a substrate, an adhesion layer disposed on the substrate, and the polyimide film disposed on the adhesion layer,
measuring a force applied to the laminate and an indentation depth of the laminate while indenting the laminate using an indenter, and estimating an indentation hardness of the polyimide film using the measured force applied to the laminate and the indentation depth of the laminate.

18. The method of claim 17, wherein the indentation depth of the laminate is less than or equal to a sum of a thickness of the polyimide film and a thickness of the adhesion layer.

19. The method of claim 17, further comprising increasing the force applied to the polyimide film so that the indentation depth of the laminate is greater than or equal to a thickness of the polyimide film.
